(19) United States
(12) Patent Application Publication
(10) Pub. No.: US 2014/0030304 A1
(43) Pub. Date: Jan. 30, 2014

(54) Process for the Treatment of Synthetic Textiles with Cationic Biocides

(71) Applicants: Sebastian Koltzenburg, Neustadt (DE); Thomas Gottschalk, Mannheim (DE); Volodymyr Boyko, Mannheim (DE); Thomas Glen Cunkle, Stamford, CT (US); Carmen Hendricks-Guy, White Plains, NY (US)

(72) Inventors: Sebastian Koltzenburg, Neustadt (DE); Thomas Gottschalk, Mannheim (DE); Volodymyr Boyko, Mannheim (DE); Thomas Glen Cunkle, Stamford, CT (US); Carmen Hendricks-Guy, White Plains, NY (US)

(73) Assignee: BASF SE, LUDWIGSHAFEN (DE)

(21) Appl. No.: 13/939,368

(22) Filed: Jul. 11, 2013

Related U.S. Application Data
(63) Continuation-in-part of application No. 13/440,301, filed on Apr. 5, 2012.
(60) Provisional application No. 61/473,168, filed on Apr. 8, 2011.

(51) Int. Cl. A01N 25/10; A01N 37/52; A01N 33/12

(52) U.S. Cl. CPC A01N 25/10; A01N 33/12; A01N 37/52
USPC 424/411; 514/642; 514/636

(57) ABSTRACT

A process for the treatment of a synthetic textile (T) with a cationic biocide (B) and at least one anionic polymer (P) which comprises the step of treating the synthetic textile with an aqueous composition containing the cationic biocide (B) in a concentration (c1) and containing the anionic polymer (P) in a concentration (c2), wherein the concentrations (c1) and (c2) are selected so that the ratio (R) of negative charges of the anionic polymer (P) to the positive charges of the cationic biocide (B) is between 10:1 and 1:1, leads to textiles with long term biocide activity.

This application is a continuation in part of U.S. Ser. No. 13/440,301 filed Apr. 5, 2012 the contents of which are wholly incorporated by reference.

### SPECIFICATION

The present invention relates to a process for the treatment of synthetic textiles with cationic biocides which leads to anti-microbial textiles having improved properties. The invention also relates to biocide compositions for the treatment of textiles.

Leach-resistant, anti-microbial nonwoven textiles are known since many years. These textiles can be prepared by treating the surface of the textile with a solution of a biocide, e.g. of a quaternary ammonium salt.

Anti-microbial for purposes of this application means virucidal, bactericidal and fungicidal including antibiotic resistant pathogens.

The prevalence of severe infections has implications for persons working in the healthcare field. The so-called “nosocomial infections” are infections that are often the result of a treatment in a hospital. These infections often first appear about 2 days after hospital admission or within 30 days after discharge and can be dangerous as many pathogens found in healthcare settings are resistant to typical antibiotics. Hospital-acquired infections may develop from surgical procedures, but microbe-contaminated textiles also play an important role. The occurrence and spread of nosocomial infections depends on the microorganism's ability to colonize and survive on surfaces of e.g. surgical equipments or textiles. The transmission of microbes from contaminated surfaces to an uncontaminated surface, such as from a textile to an open wound, can spread diseases. It is therefore important that the microbes transferred are killed before the carrier comes into contact with a non-protected surface. Conventional biocide treatments are often not effective enough at killing and immobilizing pathogens on such surfaces in the short period of time required, e.g. from 1 to 5 minutes, or they are difficult to be applied.

In addition to being lethal to pathogens, the compatibility of the anti-microbial treatment with the textiles and the durability of the treatment once applied must be taken into account. The loss of the biocide to the environment during use or storage of the textile must be prevented for efficacy to be retained and to prevent build up of the biocides in soil and water. A technical process for application should provide a biocide textile that is extremely fast acting in the destruction of pathogens and which will not leach the actives to the environment.

Many biocides are known for decades, such as silver, silver salts, triclosan, quaternary ammonium salts and polyhexamethylen-biguanid compounds.

Several fast acting cationic biocides, such as quaternary ammonium salts are known, but they need to be specifically formulated for use in textiles, in particular for medicinal textile applications.

Charged biocides, having e.g. several positively charged amino groups, do normally not adhere to non-polar, uncharged surfaces, such as nonwoven polypropylene fabrics. These biocides need to be formulated with compounds such as carboxymethylcellulose in order to allow their deposition on nonwoven polypropylene substrates.

Synthetic (non-woven) textiles, such as polypropylene fabrics, are widely used for medicinal purposes, e.g. in hospitals, but the processes for the application of cationic biocides to synthetic non-woven textiles in order to produce a fast acting and durable biocide finish have been difficult to realize.

The document U.S. Pat. No. 2,931,753 discloses salts of polysaccharide carboxylic acids, such as carboxymethyl cellulose, and quaternary ammonium salts which can be formed on cellulosic fabrics to provide a biocide surface treatment. The document U.S. Pat. No. 2,984,639 discloses a water insoluble, germicidal material which is a salt formed from a quaternary amine and a synthetic, carboxylic acid containing polymer. The salt is soluble in organic solvents and can used to form films or can be added to film forming compositions such as paints.

The document U.S. Pat. No. 4,615,937 describes an biocidely active, non-woven web, comprising synthetic and/or cellulosic fibers, organo-silicon quaternary ammonium salts, and a suitable latex binder. The documents U.S. Pat. No. 4,783,340 and U.S. Pat. No. 5,158,766 disclose an biocide surface treatment, suited for spraying or other application to hard surfaces, comprising ammonium salts and anionic polymers. The document US 2007/0048356 describes the use of polyhexamethylenbiguanid (PHMB) with a second biocide agent to create an biocide coating for nonwovens. The document US 2007/0042198 discloses creating an biocide surface using organo-silicon quaternary ammonium salts and cationic, hydrophilic polymers. The document U.S. Pat. No. 4,721,511 discloses leach-resistant biocide non-woven fabrics comprising a non-woven substrate, e.g. cellulose, polyethylene or polypropylene, a silicone quaternary amine, and an organic titanate, useful as a crosslinking agent for the silicone quaternary amine.

Despite the progress in this area, there is still a need for improved processes for preparing biocide non-woven fabrics from synthetic polymers, such as polypropylene, and other synthetic fibers. The textiles should possess the ability to quickly, and efficiently kill pathogens upon very brief exposure, e.g., reducing the bacterial population in a range of 99.99% within several minutes of contamination (e.g. within 120 minutes).

It has been found that a process for treating a synthetic textile with a certain ratio of cationic biocide(s) and selected anionic polymer(s) provides the textile, in a simple to be applied way, with a durable, biocide surface with extremely efficient and quick killing biocide activity.

The present invention relates to a process for the treatment of a synthetic textile (T) comprising a biocide dispersion comprising a coacervate or complex of (at least) a cationic biocide (B) and (at least) an anionic polymer (P). This process comprises the step of treating the synthetic textile with an aqueous composition containing the cationic biocide (B) in a concentration (c1) and containing the anionic polymer (P) in a concentration (c2), wherein the concentrations (c1) and (c2) are selected so that the ratio (R) of negative charges of the anionic polymer (P) to the positive charges of the cationic biocide (B) is between 10:1 and 1:1, preferably between 2.5:1. This ratio is often between 2.3:1 and 1.05:1.

In one embodiment, the anionic polymer is carboxymethylcellulose, alginic acid, hyaluronic acid, a homopolymer or copolymer of alpha beta-unsaturated carboxylic acids, alpha, beta-unsaturated dicarboxylic acids such as homopolymers or copolymers of acrylic or methacrylic acid, itaconic acid, crotonic acid, maleic acid, fumaric acid and salts thereof and the like.

In another embodiment the anionic polymer is a water soluble polymer or copolymer which is characterized by a pH of greater than 7 in use, preferably greater than 8 in use when measured at 10 wt. % in distilled water under DIN 19268. Ideally the anionic polymer is miscible in water forming a colloidal solution.

Typical water soluble anionic polymers may be purchased from BASF Corporation, Florham Park NJ under the tradename Sokalana For example Sokalan® CP 5, Sokalan® CP 45, Sokalan® CP 7, Sokalan® CP 9, Sokalan® CP 10, Sokalan® HP 25 and Sokalan® HP 53 are such water soluble anionic polymers.

In one embodiment two different anionic polymers are used. For example a first anionic polymer (P1) may be carboxymethylcellulose, alginic acid or hyaluronic acid. Typically if the anionic polymer is carboxymethylcellulose (either P or P1) it may have a degree of substitution ranging from about 0.2 to about 1.2, for example about 0.4 to about 0.95.

A second anionic polymer (P2) may be a homopolymer or copolymer of alpha beta-unsaturated carboxylic acid, alpha,beta-unsaturated dicarboxylic acids such as homopolymers or copolymers of acrylic, methacrylic acid, itaconic acid, crotonic acid, maleic acid, fumaric acid and the like.

The first anionic polymer (P1), for example carboxymethylcellulose forms a complex or coacervate with the cationic biocide (B). For example cetyltrimethylammonium chloride maybe (B) and P1 may be carboxymethylcellulose, alginic acid or hyaluronic acid.

A second anionic polymer (P2) may be added to stably disperse the complex or coacervate. This second anionic polymer (P2) also has the additional benefit of boosting overall anionic charge making it possible to increase the concentration (c1) of the active, the cationic biocide (B) dispersions making the dispersion more potent for treating the nonwoven.

The second anionic polymer (P2) is for instance soluble in water, is characterized by a pH above 7 in use and makes up about 5 to 50 wt. %, for example about 8 to about 30 or about 10 to about 25 wt % of the first anionic polymer (P1).

The anionic polymer (P or P1) may be a copolymer of carboxylic acid containing monomers comprising an alpha, beta-unsaturated carboxylic acid including methacrylic acid, acrylic acid, itaconic acid, crotonic acid, maleic acid, fumaric acid and salts thereof and a nonionic monomer selected from the group consisting of olefinic monomers such as diisobutylene, butylene, ethylene, propylene or the like, acrylamide, (meth)acrylamide, N-methyl(meth)acrylamide, N,N-dimethyl(meth)acrylamide and C₁-C₆ (meth)alkyl acrylates.

The C₁-C₆ alkyl(meth)acrylates are for example methyl, ethyl, n-propyl, isopropyl, butyl, t-butyl, isobutyl, pentyl and hexyl(meth)acrylates.

When the anionic polymer is a copolymer of carboxylic acid containing monomers the carboxylic acid containing monomers make up about 10 to about 95 weight %, for example 20 to about 90 weight % or about 30 or 40 to about 85 weight % of the total wt. % of the copolymer.

Typically the anionic copolymer may comprise about 30, 40 or 50 weight % of (meth)acrylic acid, itaconic acid, crotonic acid, maleic acid, fumaric acid and the like.

The anionic polymer or copolymer (P1 or P) weight average molecular weight can range broadly from about 1000 to about 1,000,000 g/mol, for example about 2000 to about 500,000, about 3000 to about 250,000 g/mol or about 4000 to about 175,000 or 200,000.

The invention also relates to a process for the treatment of a synthetic textile (T) comprising a biocide dispersion comprising a coacervate or complex of (at least) a cationic biocide (B) and an anionic polymer (P), wherein the synthetic textile (T) comprises a synthetic polymer from the group of:
polyolefins, polyesters and polyamides, preferably from the group of polypropylene, polylethylene, polypropylene/polylethylene copolymers, polyethyleneterephthalate (PET), nylon and styrenic co-polymers.

The invention further relates to a process for the treatment of a synthetic textile (T) with a cationic biocide (B) and an anionic polymer (P) coacervate or complex, wherein the anionic polymer (P) is an anionic polyelectrolyte selected from the group of:

carboxymethyl cellulose, alginic acid, hyaluronic acid, poly(acrylic acid), copolymers of (meth)acrylic acid and (meth)acrylamide, N-methyl(meth)acrylamide, N,N-dimethy(meth)acrylamide and copolymers of maleic acid, itaconic acid, crotonic acid, maleic acid, fumaric acid and diisobutylene, butylene, ethylene, propylene.

Often the anionic polymer (P) is an anionic polyelectrolyte selected from the group of:
carboxymethyl cellulose, alginic acid, copolymers of maleic acid and copolymers of (meth)acrylic acid with acrylic acid esters, copolymers of (meth)acrylic acid with acrylamide.

These anionic polymers (P) often have one or several carboxylic groups, sulfonic groups and/or maleic acid groups. Often the anionic polymers (P) have several (e.g. more than 10) carboxylic groups.

The invention relates to a process for the treatment of a synthetic textile (T) with a cationic biocide (B) and an anionic polymer (P), wherein the cationic biocide (B) is selected from the group of:
quaternary ammonium compounds of the formula (I):

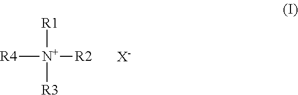

wherein R₁, R₂, R₃ and R₄ are independent of each other C₁₋₂₀ alkyl, C₁₋₂₀ alkyl alkyl substituted by one or more hydroxy or benzyloxy group and/or interrupted by one or more oxygen, C₇₋₁₅ aralkyl, or C₇₋₁₅ aralkyl substituted by one or more C₁₋₂₀ alkyl, hydroxy, C₁₋₂₀ alkyloxy and/or benzyloxy groups, and
X⁻ is a halide (for example, chloride, bromide or iodide), hydroxide, phosphate, phosphonate, carbonate, sulfate, carboxylate anion, nitrate, methosulfate or acetate;
polyhexymethylenbiguanid compounds;
a combination of both types of cationic biocides.

The invention relates to a process for the treatment of a synthetic textile (T) with (at least) a cationic biocide (B) and an anionic polymer (P), wherein an aqueous composition is used,

comprising 0.05 to 5%, often 0.1 to 5% or 0.5 to about 4% by weight (based on the total weight the aqueous composition) of a cationic biocide (B) and comprising 0.05 to 10%, often 0.1 to 10% or 0.1 to about 5, 6, 7 or 8% by weight (based on the total weight the aqueous composition) of an anionic polymer (P) or (P1+P2).

The invention also relates to a process for the treatment of a synthetic textile (T) with (at least) a cationic biocide (B) and an anionic polymer (P), wherein an aqueous composition, comprising 0.05 to 5%, often 0.1 to 5% by weight (based on the total weight the aqueous composition) of a cationic biocide (B) and comprising 0.05 to 10%, often 0.1 to 10% by weight (based on the total weight the aqueous composition) of an anionic polymer (P) is sprayed onto the synthetic textile (T). In one embodiment, the aqueous composition with the two components (B and P) is formed during the spraying process, e.g. by using two separate compositions and combined or separate nozzles. According to a different embodiment, the synthetic textile (T) is dipped into such aqueous composition, comprising 0.1 to 5% by weight (based on the total weight the aqueous composition) of a cationic biocide (B) and comprising 0.1 to 10% by weight (based on the total weight the aqueous composition) of an anionic polymer (P).

The invention also relates to a process for the treatment of a synthetic textile (T) with a cationic biocide (B) and an anionic polymer (P), wherein an aqueous composition, comprising 0.1 to 5% by weight of CetylTrimethyl Ammoium Chloride (CTAC) and/or PHMB (as cationic biocide) and comprising 0.1 to 10% by weight (based on the total weight the aqueous composition) of at least one anionic polymer (P) selected from the group of copolymers of acrylic acid with acrylic acid ester and copolymers of methacrylic acid with acrylic acid ester, carboxy methyl cellulose, alginic acid, hyaluraonic acid, acid or methacrylic acid with acrylamide copolymers and copolymers of maleic acid and olefinic monomers such as diisobutylene, butylene, ethylene, propylene are used.

The synthetic textile (T) is preferably based on polypropylene.

A further aspect of the invention relates to a biocide composition for the treatment of a synthetic textile (T) comprising a cationic biocide (B) and an anionic polymer (P). This composition preferably is stable at room temperature (and up to 50° C.) against decomposition for at least 10 weeks, preferably 6 months.

This composition often is an aqueous composition but also can be a powder formulation, after removing the solvent(s). The biocide composition is preferably containing the cationic biocide (B) in a concentration (c1) and containing the anionic polymer (P) in a concentration (c2), wherein the concentrations (c1) and (c2) are selected so that the ratio (R) of negative charges of the anionic polymer (P) to the positive charges of the cationic biocide (B) is between 10:1 and 1:1, preferably between 2.5:1 and 1:1. It is preferred that this ratio is between 2.3:1 and 1.05:1.

The cationic biocide (B) and an anionic polymer (P) are preferably homogenously distributed within the composition.

The invention also relates to a biocide composition for the treatment of a synthetic textile (T) which is an aqueous composition and which achieves a reduction in microbial activity on the synthetic textile (T) of at least log 3, often log 3.5 or better log 4 against gram positive and gram negative bacteria within 5 minutes of the contamination.

Further, the invention quickly and efficiently kills pathogens such as viruses, antibiotic resistant bacterial such as Methicillin-resistant Staphylococcus aureus (MRSA) and Pseudomona aeruginosa also characterized by low antibiotic susceptibility. In addition to this intrinsic resistance, P. aeruginosa easily develops acquired resistance.

Thus the treated nonwoven and the antimicrobial dispersion is active against many pathogenic organism such as Listeria spp, Salmonella spp, Campylobacter spp, Actinomyces spp, C. difficle, C. perferengies, VRE (vancomycin resistant enterococci), Candida albicans, E. coli, E. faecalis, Staphylococcus saprophyticus, Citrobacter diversus, Proteus mirabilis, Enterobacter aregenes, Enterobacter clocae, Salmonella enterica, Staphylococcus aureus, Klebsiella pneumonia, Aspergillus niger, Aureobasidium pullulans, Penicillium funiculosum, Methicillin-resistant Staphylococcus aureus (MRSA) Streptococcus Pneumonia and Pseudomonas aeruginosa including all viruses and fungi.

Thus the process of treating the synthetic textile of the invention offers surprising protection from antibiotically resistant organisms and viruses as is shown in the examples described below.

The invention also relates to a biocide composition for the treatment of a synthetic textile (T), containing at least 50% by weight of water and containing as cationic biocide (B) 0.05 to 5%, preferably 0.1 to 5% by weight of at least one compound from the group of cetyltrimethyl-ammonium salts and polyhexamethylenbiguanid compounds, preferably CTAC and/or PHMB.

The invention also relates to a biocide composition for the treatment of a synthetic textile (T), containing 0.1 to 5% by weight of at least one anionic polymer (P) selected from the group of carboxymethyl cellulose, alginic acid, poly(acrylic acid), copolymers of acrylic acid, poly(methacrylic acid) and copolymers of methacrylic acid. The negative charges of these anionic polymers can be determined by known methods.

The ratio (R) of negative charges of the anionic polymer (P) to the positive charges of the cationic biocide (B) for the treatment of textiles often is between 2.5:1 and 1:1, it is preferred that this ratio is between 2.3:1 and 1.05:1.

The biocide dispersion may comprise other components in addition to the cationic biocide (B) and the anionic polymer (P).

For example, the dispersion may contain additional dispersing agents such as surfactants and nonionic polymers. Miscellaneous ingredients such as water-miscible solvents, buffers, fragrances, dyes, pigments, adhesion promoters and thickeners are also considered.

The surfactants considered may be amphoteric, anionic, cationic or nonionic. Detersive surfactants may be avoided such as those used primarily in cleaning solutions. Detersive surfactants are normally selected from anionic, zwitterionic and amphoteric surfactants.

The nonionic polymers would include polyvinyl alcohol, polyvinyl pyrrolidone, polyacrylamide, polyethylene oxide, polypropylene oxide, polyvinylacetate and mixtures thereof.

The water-miscible solvents may be selected from C₁₋₆ alkanol, C₁₋₆ diols, C₃₋₂₄ alkylene glycol ethers, and mixtures thereof. The alkanol can be selected from methanol, ethanol, n-propanol, isopropanol, butanol, pentanol, hexanol, their various positional isomers, and mixtures of the foregoing. It may also be possible to utilize in addition to, or in place of, said alkanols, the diols such as ethylene, propylene and butylene glycols, and mixtures thereof.

Buffers may be added to alter the pH of the dispersion. For example NaOH, KOH and the like may be added in order to increase the solubility of the anionic polymer (P) and accordingly help to maintain the overall stability of the biocide dispersion of the coaceravate or complex.

A further aspect of the invention is a process for the preparation of an aqueous biocide composition as described above, comprising the steps of:
a) preparing an aqueous solution of at least one anionic polymer (P),
b) preparing an aqueous solution of at least one cationic biocide (B),
c) mixing the two aqueous solutions, preferably turbulently
d) potentially removing the solvent from the biocide composition.

The amounts chosen of the aqueous solutions preferably is made in a way that the ratio (R) of negative charges of the anionic polymer (P) to the positive charges of the cationic biocide (B) is between 2.5:1 and 1:1. It is preferred for this ratio to be between 2.3:1 and 1.05:1.

It is also possible to slowly or rapidly add the solution of the cationic biocide (B) to the solution of the anionic polymer (P), but by turbulently mixing, the particles formed in the composition often have a better particle size (e.g. 90% in the diameter-range from 200 to 900 nm).

The invention also relates to a synthetic textile (T) comprising a cationic biocide (B) and an anionic polymer (P) prepared by using a process as described above. The synthetic textile (T) can further comprise a nonionic surfactant.

The invention also relates to an article comprising a synthetic textile (T) as described, in particular a surgical drape, a cover, a drape, a sheet, a linen, a padding, a gauze dressing or a garment, such as gown, robe, face mask, head cover, shoe cover or glove.

The synthetic textiles (T) to be treated according to the invention preferably is made from synthetic polymer fibers of polypropylene (PP), polyethylene (PE), polyethyleneterephthalate (PET) or polyamide. Preferably nonwoven polypropylene textiles are treated.

The anionic polymer (P) component preferably is an anionic polyelectrolyte such as carboxymethyl cellulose, various copolymers of acrylic acid, poly(methacrylic acid), various copolymers of methacrylic acid, such as copolymers of methacrylic acid with PEG-esters of methacrylic acid (such as Sokolan) or copolymers of methacrylic acid with esters of acrylic acid (such as the commercial product Kollicoat MAE 100, BASF, Germany).

Particularly useful as anionic polymer (P) are the copolymers Kollicoat MAE 30 DP and Kollicoat MAE 100 P, (provider: BASF SE, Germany) which are copolymers derived from methacrylic acid/ethyl acrylate.

These copolymers can be used as film-formers, e.g. in the pharmaceutical industry for the production of enteric coatings for solid dosage forms, and have the following chemical structure, with n and m being integers, often n and m are >100.

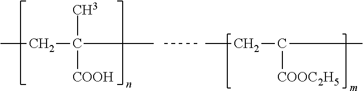

The ration of the monomer components in the copolymer is roughly 1:1. The Kollicoat MAE grades have an anionic character, which is defined by the number of carboxy-groups per molecule. The average molecular weight M_{w} is of the order of 250,000, (often between 150,000 and 300,000 g/mol). The product Kollicoat MAE 100 P has been treated with sodium hydroxide to neutralize about 6 mol-% of the (negatively charged) carboxyl groups.

The biocide textiles (T) prepared according to the process described are superior to the known materials e.g. because the biocide action is fast and more effective in reducing the potential of transmitting harmful pathogens, such as bacteria and fungi. For example, the present fabrics reduce bacterial populations 99.99% within several minutes of contamination.

The invention also relates to a synthetic textile (T) with a cationic biocide (B) and an anionic polymer (P), comprising:
a) synthetic polymer fibers (T), for example fibers of PP or PE,
b) at least one anionic polymer (P) such as carboxymethyl cellulose, copolymers of acrylic acid and copolymers of methacrylic acid, and
c) a cationic biocide (B), in particular a compound of the formula (I)

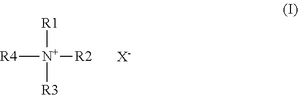

wherein R₁, R₂, R₃ and R₄ are independent of each other C₁₋₂₀ alkyl, said alkyl substituted by one or more hydroxy or benzyloxy group and/or interrupted by one or more oxygen, C₇₋₁₅ aralkyl, or said aralkyl substituted by one or more C₁₋₂₀ alkyl, hydroxy, C₁₋₂₀ alkyloxy and/or benzyloxy groups, and
X⁻ is a halide (for example, chloride, bromide, iodide), hydroxide, phosphate, phosphonate, carbonate, sulfate, carboxylate anion, nitrate, methosulfate or acetate.

The term C₁-C₂₀ alkyl (as well as, for example C₆-C₂₀-, C₁₀-C₂₀-, C₁₀-C₁₈- C₁-C₁₂-, C₁-C₈-, C₁-C₆- or C₁-C₄alkyl) means a branched or unbranched alkyl chain containing the that number of carbon atoms, which include for example, methyl, ethyl, propyl, butyl, pentyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, isopropyl, isobutyl, tert-butyl, isopenty, neopentyl, 2-ethylhexyl, iso-octyl, tert octyl and the like.

Likewise, the term alkoxy, such as C₁-C₂₀-, C₁-C₁₂-, C₁-C₁₀-, C₁-C₈-, C₁-C₆- or C₁-C₄alkoxy is a branched or unbranched alkyl chain containing the specified number of carbons which are connected to the rest of the compounds through an oxygen atom and includes for example, methoxy, ethoxy, propoxy, isopropoxy, n-butyloxy, sec-butyloxy, iso-butyloxy, tert-butyloxy, pentyloxy, hexyloxy, heptyloxy, 2,4,4-trimethylpentyloxy, 2-ethylhexyloxy, octyloxy, nonyloxy, decyloxy or dodecyloxy, for example, methoxy, ethoxy, propoxy, isopropoxy, n-butyloxy, sec-butyloxy, iso-butyloxy, tert-butyloxy. The term C₇₋₁₅ aralkyl is for example benzyl, phenethyl, phenypropyl, cumyl, napthylmethyl, napthylethyl, napthylpropyl and the like.

The cationic biocides can be selected from mono-long-chain, tri-short-chain tetraalkyl ammonium compounds; di-long-chain, di-short-chain tetraalkyl ammonium compounds; trialkyl, mono-benzyl ammonium compounds, and mixtures thereof. By “long” chain is meant alkyl of 6 or more carbon atoms. By “short” chain is meant alkyl of 5 or fewer carbon atoms. Typically, at least one of the groups R₁, R₂, R₃ and R₄ is a long chain alkyl or a benzyl group.

In one embodiment, the cationic biocide (B) is selected from:
alkyldimethylbenzylammonium compounds, didecyldimethylammonium compounds and cetyltrimethylammonium compounds, for example alkyldimethylbenzylammonium chlorides, didecyldimethylammonium chloride and cetyltrimethylammonium chloride.

In one particular embodiment the cationic biocide is cetyltrimethylammonium chloride (CTAC).

Instead of the compound of the formula (I) another cationic biocide (B) can be chosen, in particular a biguanide biocide compounds, such as known compound polyhexamethylen-biguanid (PHMB). The cationic character of this compound can be directed by the process of its preparation; n is an integer.

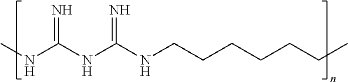

More than one cationic biocide agent can be used, e.g. combinations of PHMB with a cetyltrimethylammonium salt, and other biocides may also be present, such as triclosan or silver based biocides.

The anionic polymers (P), e.g., anionic polyelectrolytes, are those which will form a water insoluble complex with cationic biocide and can be naturally ocurring, synthetic or synthetically modified polyanions and include cellulose, cellulose derivatives, carboxy containing polysaccarides, synthetic polymers prepared from ethylenically unsaturated carboxylic acid monomers and the like. The anionic polyelectrolytes are often selected from carboxymethyl cellulose, alginic acid, poly(acrylic acid), copolymers of acrylic acid, poly(methacrylic acid) and copolymers of methacrylic acid. The latter group shows advantageous properties.

Other processing and formulating components can be used in the compositions, such as:
wetting agents, colorants, anti-oxidants and other stabilizers, antistats, surfactants, rheology control agents, defoamers or odor control agents.

The synthetic textiles of the invention comprise synthetic polymers, or consist of these polymers, such as for example:
polyolefins, polyesters and polyamides, for example, polypropylene, polylethylene, polypropylene/polylethylene copolymers, PET, Nylon, polylactic acid and polyglycolic acid polymers and copolymers thereof, polybutylene, styrenic copolymers.

More than one type of synthetic polymer may be present, and naturally occurring polymers may also be present in the textile.

Also provided is a process by which the synthetic textiles are prepared. The textiles comprising the anionic polymer (P) and cationic biocide (B) of the present invention can be fabricated according to a number of processes which comprise adhering the select cationic biocide (B) to the fabric polymers using anionic polymer (P). The polymer (P) and biocide compounds may preferably be applied to the fabric together as parts of a single composition, or individually in separate steps. Any standard application method may be employed, e.g., padding, spraying, simple immersion or other coating method. Any of the compositions (solutions or suspensions or dispersions) applied during the process steps may also include a processing aid such as an alcohol, wetting agent, surfactant, viscosity modifier, binding agent surface modifier, salts, defoamers or pH-modifiers.

As polypropylene textile and many other synthetic fibers are hydrophobic it may in some cases be useful to modify the surface of the fibers to improve wettability so the aqueous compositions can be applied to the textiles more quickly and evenly. Many methods are known in the art and include surface active additives, like IRGASURF HL 560 (BASF SE, Germany) or plasma surface treatment to add hydrophilic functionality to the surface of the fibers.

In one embodiment of the invention, the anionic polyelectrolyte (P) is applied from one solution and the cationic biocide (B) is applied from a second solution, but a composition comprising both components is formed in situ on the surface of the synthetic textile. Typical examples are spray-processes using two different sources but combined nozzle(s).

Stable compositions (dispersions) with coacervate particles comprising the biocide (B) can be obtained by a continuous precipitation process (e.g. turbulent mixing).

The flow of two liquids with high Reynolds numbers usually becomes turbulent, while the flow with low Reynolds numbers usually remains laminar. For example, a Reynolds number of more than 4000 will correspond to turbulent mixing, while a Reynolds number below 2000 indicates a laminar flow of the liquids. In turbulent flow, unsteady vortices appear on many scales and interact with each other.

These biocide compositions can be applied to synthetic textiles or fabric. Fabrics treated with these compositions showed biocide efficacy. In particular, nonwoven polypropylene (PP) materials are used for surgical tissues and clothing. As a consequence of increased proliferation of germs, such as methicillin-resistant Staphylococcus aureus (MRSA), equipping these synthetic fabrics with biocide substances appears commercially interesting.

The polymer (P) and biocide (B) can be applied to the material substrate via conventional saturation processes such as a so-called “dip and squeeze” or “padding” technique. The “dip and squeeze” or “padding” process can coat both sides of the textile and the bulk of the substrate with the biocide composition. When dipped in a bath, the bath may preferably be a composition containing all components, or multiple step processing using separate compositions for individual components.

Alternatively, the composition, or some of the components can be applied by spraying a composition of the components. The two components (P) and (B) can also be sprayed separately onto the surface of the synthetic textile. According to other aspects of the invention, the steps of dispensing the first and second composition (one for polymer (P) and one for biocide (B)) are performed by spraying the first and second compositions through separate nozzles. The nozzle may spray in a substantially fan-shaped pattern or, alternatively, may be sprayed with one of the compositions being sprayed in one spray pattern and the second composition being sprayed in a second spray pattern that intersects with the first spray pattern. The spray pattern may be two fan shaped spray patterns or two hollow conical spray patterns that mix external to the spray head and intersect above the textile. The first and second compositions (with polymer (P) and biocide (B)) may be sprayed together prior to being deposited on the synthetic textile. The method may also include applying a coating on the textile prior to dispensing the components.

According to another aspect of the invention, a post-mix spray nozzle assembly is provided for forming intersecting coaxial hollow conical spray patterns.

The spray nozzle includes a central nozzle connected to a first liquid source forming a hollow conical spray pattern. An annular nozzle is coaxially oriented with the central nozzle forming a second hollow conical spray pattern of a second liquid. The two hollow conical spray patterns intersect in space remote from the nozzles forming a hollow generally conical spray pattern. For details of this spaying method, reference is made to U.S. Pat. No. 6,872,337.

For example a textile, e.g. a polypropylene nonwoven fabric can be soaked in an aqueous solution containing carboxymethyl cellulose and the biocide (B) (in the particular ratio) until completely wetted. The excess composition is removed by padding and then the textile is air dried followed by drying in an 80° C. oven. Further general discussion of preparation methods can be found in the literature, for example U.S. Pat. No. 4,721,511.

In certain cases, the polymer (P) and biocide (B) of the invention are applied to only one side of the textile or article. It may be desirable, when treating a multilayered fabric, to apply the polymer (P) and biocide (B) to only one of the layers. For example, a hospital gown may be prepared from a non-woven material wherein only the side away from the patient is treated according to the invention, thus the exterior of the garment which is exposed to contamination is treated while the side covering the patient is free of the biocide treatment. Any method of contacting the surface of the textile with the polymer and biocide may be employed, such as spraying. Other common techniques in the nonwoven textile industry useful for this purpose include rotary screen, reverse roll, Meyer-rod (or wire wound rod), gravure, slot die and gap-coating.

The choice of processing techniques is dependent on a number of factors, which include viscosity, concentration or solids, amount of material to be deposited on the textile, surface profile of the textile to be coated. Often, the composition will require some formulation modifications of concentration, viscosity, wettability or drying characteristics to optimize the performance.

The concentration of the anionic polymer (P) and the biocide (B) and the amount of composition sprayed or otherwise applied onto the synthetic textile is readily adjusted to achieve the desired loading. Polymer (P) loading of from about 0.1 to 10 weight have been found to be useful and loadings of the biocide (B) from about 0.1 to about 5 wt/wt % of the total weight of the composition were found to be very effective.

The textile (T) may be treated with the composition comprising polymer and biocide on a single side of the material or on both sides. If the textile has multiple layers, it may be desirable to treat only a single layer. The biocide composition can be selected so that it permeates only a part of the material, e.g., up to about 15 micron of a textile, but it is also possible to fully saturate the textile material throughout its bulk.

The textile which is treated with the polymer (P) and biocide (B) of the present invention can be a fabric which is subsequently used to make a finished article, or the composition may be applied to a finished article comprising the textile. The invention also provides protective articles comprising the composition comprising synthetic polymer fibers, biocide compound (B), and anionic polymer (P). Commercial articles produced using the compositions and methods of the invention include, among others, a protective article worn by patients, healthcare workers, or other persons who may come in contact with potentially infectious agents or microbes, including an article of clothing such as a gown, robe, face mask, head cover, shoe cover, or glove. The protective article may include a surgical drape, surgical fenestration or cover, drape, sheets, bedclothes or linens, padding, gauze dressing, wipe or sponge for household, institutional, health care and industrial applications.

The biocide textile comprising the synthetic polymer (P) of the present invention may also encompasses other materials, natural or synthetic fibers or combination blends of the two, elastic and non-elastic, porous and non-porous membranes or films, and laminates or combinations thereof. Other substrates may include rubber, metal, steel, glass or ceramic materials.

The feel of the textile, especially when held in close contact with the skin is an important consideration, especially with synthetic fibers that may not be sufficiently soft or supple. Additives incorporated into the polypropylene textile can improve the hydrophile character of the textile and impart a soft, comfortable feel to polyproylene non-woven fabrics. The commercial product IRGASURF HL 560 is an example of this type of additive. It has been found that the polymer and biocide combination in the particular ratio of the instant invention performs extremely well on fabrics treated with such products.

The binding of cationic biocides (B) such as quaternary ammonium salts to surfaces such as polypropylene which is a non-polar polymer and contains no hydroxyl or other functionality that might complex with the salt can create difficulties and binders are often employed for this purpose. However, binders that are effective in preventing the leaching or loss of the ammonium salt can hinder its biocide activity.

The selected anionic polymers (P) and biocides (B) of the invention create a highly active and durable finish to synthetic textiles. The durability can be illustrated by soaking a sheet prepared by the present methods in water for one hour, removing the sheet from the water bath, rinsing with fresh water and then spraying with an indicator dye bromophenol blue. Bromophenol blue has a high affinity for the cationic biocide of the invention.

The retention of the blue dye on the fabric indicates that the cationic biocide is durably bound to the fabric and has not been rinsed away with the water soak. The durability of the textile does not compromise the biocide activity and the high quick kill efficiency is maintained, i.e., a log reduction of at least 3.5 (or at least 4) colony forming units per sample [cfu/sample] within 5 minutes of exposure.

Cetyltrimethyl ammonium chloride (CTAC) and PHMB have shown excellent biocide activity in the present invention and carboxymethyl cellulose and several copolymers (from methacrylic acid and acrylic-esters) have each proven to be excellent choices as anionic polymers.

Further, in addition to the quaternary ammonium salt as biocide (B), other biocide agents may also be added, for example, a biguanide such as poly-hexamethylene biguanide hydrochloride, a chlorohexine, an alexidine, and relevant salts thereof. Stabilized oxidants including stabilized peroxides, sulfides, sulfites such as sodium metabisulfite, polyphenols, bis-phenols including triclosan and hexachlorophene etc, other quaternary ammonium compounds including quaternary ammonium siloxanes, cetyl pyridinium chloride, quaternized cellulose and other quaternized polymers; biocide metals and metal-containing compounds, a halogen-releasing agent or halogen-containing polymer, a thiazole, a thiocynate, an isothiazolin, a cyanobutane, a dithiocarbamate, a thione, a triclosan, an alkylsulfosuccinate, various “naturally occurring” agents for example polyphenols from green or black tea extract, citric acid, chitosan, anatase TiO₂, tourmaline, bamboo extract, neem oil etc, hydrotropes (strong emulsifiers) and chaotropic agents (alkyl polyglycosides) and synergistic combinations thereof.

The invention is illustrated by the following examples and patent claims.

### EXAMPLES

### Materials Used for Testing

Nonwoven polypropylene (PP) textils (T) are used for the described experiments.

Two specific cationic biocides (B), cetyltrimethylammonium chloride (CTAC)

and polyhexamethylenbiguanid (PHMB), are combined with
a) either carboxymethylcellulose (CMC in its free acid form, pKa=4) or with
b) a commercially available methacylic acid copolymer (of BASF)

in order to allow for deposition of the biocides (B) on PP-textiles.

Stable compositions (dispersions of complex coacervate particles) were obtained under specific conditions.

The biocide efficacy of the synthetic textiles treated with such formulations is shown.

The biocide activity is tested following the AATCC standard 100-1999 for the assessment of antibacterial finishes on textile materials. The virucidal activity is determined using AATCC test Method 100-2004 with customization to virus testing. Synthetic textiles treated with a biocide composition are inoculated with a defined cell count of a specific test organism. Untreated surfaces are also inoculated and serve as blank controls. After incubation, the cell count on the biocide treated surfaces is determined and compared to the cell count of the untreated control. Zero hour cell count is also determined for the control panels. Selection of the test strains depend on the target application for the synthetic textile material. Some commonly used strains are:
Staphylococcus aureus ATCC 6538
Staphylococcus aureus DSM 799
Klebsiella pneumoniae ATCC 4352
Escherichia coli ATCC 10536
Escherichia coli DSM 682
Aspergillus niger ATCC 6275
Aureobasidium pullulans DSM 2404
Penicillium funiculosum DSM 1960
Methicillin-resistant Staphylococcus aureus (MRSA) ATTCC BAA 811
Streptococcus pneumoniae ATTCC BAA 659
Pseudomonas aeruginosa ATCC BAA 427
Bovine Viral Diarrhea Virus (Surrogate for Human Hepatitis C Virus) Source American BioResearch laboratories
Influenza A Virus (H1N1) (2009 pandemic strain) Source Centers for Disease Control and Prevention (CDC) and Charles River Laboratories
Fhinovirus Type 14; ATCC VR-284

For the following examples, the bacteria Escherichia coli gram (−) and Staphylococcus aureus gram (+), are grown in casein-soy meal peptone broth for 16 to 24 hours at 37° C. and then diluted with 0.85% NaCl containing 0.5% Caso-Broth broth to provide a suspension with a concentration of ˜10⁷ cfu/ml. Prior to inoculation of the test textiles, the concentration is adjusted to 10⁶ cfu/ml with sterile deionised water at pH 7.4. Dow Corning® Q2-5211 superwetting agent can be added to the inoculum at a concentration of 0.01%.

Two test cationic biocide (B) components, namely cetyltrimethylammonium chloride (CTAC) and polyhexamethylenbiguanid (PHMB) are particularly effective biocides against pathogenic germs, such as S. aureus and E. coli. However, the effective direct deposition of these positively charged, water soluble biocide substances on nonpolar, uncharged PP-textile surfaces becomes possible by using a further component, the anionic polymer (P), preferably in a particular weight ratio, which depends on the electric charges of both components (B and P).

To allow for effective, durable deposition of CTAC and PHMB, complex coacervation (associative phase separation), was found a promising formulation strategy. The experiments described demonstrate that this formulation strategy is technical feasible. Several samples of synthetic textile per biocide composition are inoculated. Each sample is put in a sterile Petri dish and inoculated with an appropriate amount of biocide composition, typically 100 μl-200 μl. In some examples 200 μl is used of a suspension resulting in a final concentration of bacteria or fungi on the sample of ˜10⁶ cfu. During inoculation, the liquid must be completely absorbed or at least evenly distributed on the textile surface. In the following tests, the samples inoculated with bacteria are incubated in a humid chamber at 37° C. for 5 minutes.

After incubation, the surviving organisms are collected from textile samples by transferring the samples into “Stomacher bags” filled with 10 ml inactivation buffer which are kneaded for 1 minute. The inactivation buffer is a phosphate buffer 0.07 M at pH 7.4 containing 1% TWEEN 80 and 0.3% lecithin and prevents any active biocide from further interfering with cell growth. One ml of the liquid from either the bags or dishes is removed and diluted with sterile deionized water in steps to provide dilutions of ten fold and 1,000 fold. 100 μl of the undiluted suspensions and of the 10 and 1000 dilutions are plated out by means of a spiral plater onto Tryptic Soy Agar with inactivating agents (MERCK #18360). The plates are then incubated at 37° C. for 24-48 hours depending on bacteria used. After incubation, the visible colonies are counted and the results are given as colony forming units per sample [cfu/sample] according to the following formula cfu/plate×dilution factor×10×10.

### Example 1

### Preparation of Two Biocide Polypropylene Textiles

1a) A sheet of polypropylene textile (nonwoven fabric, 30 g/m²) is soaked in an aqueous composition comprising (w/w):
0.5% of carboxymethyl cellulose
   (average M.W. 90000, degree of substitution 0.7) and
0.25% of cetyltrimethylammonium chloride.

1b) A sheet of polypropylene textile (nonwoven fabric, 30 g/m²) is soaked in an aqueous composition comprising (w/w):
0.1% of Kollicoat MAE 100P (of BASF, Germany)
3% of an aqueous solution of NaOH (1 mol/l) and
0.1% of cetyltrimethylammonium chloride.

### Example 2

### Biocide Activity

A polypropylene textile prepared according to example 1a and containing 2% wt/wt of carboxymethyl cellulose and 1% wt/wt of cetyltrimethylammonium chloride (or alternatively according to example 1b and containing 0.5% wt/wt of Kollicoat MAE 100P (of BASF, Germany) and 0.5% wt/wt of cetyltrimethylammonium chloride) is innoculated with Escherichia coli gram (−) and Staphylococcus aureus gram (+) bacteria as described above. The innoculated samples are incubated in a humid chamber at 37° C. for 5 minutes before transferring the samples into “Stomacher bags” as above.

The sheet showed a strong reduction against E. coli and a strong reduction against S. aureus. Even after soaking treated textile samples in water for one hour before testing for biocide action, the textile still displayed a strong reduction against both E. coli and S. aureus. The above biocide test procedure can be modified for fungal cultures.

### Example 3

### Process for Preparing a Composition with Coacervate Particles

It is found that particles are formed by supramolecular interaction of the cationic biocides (B) with the anionic polymer (P), such as carboxymethylcellulose or Kollicoat MAE. At a mixing ratio, where coacervation is maximal, the complexes formed would be supposed to be charge-neutral. It is observed however that the effective deposition on the PP textile of the coacervate particles ideally is made in aqueous phase to avoid flocculation.

The anionic polymer (P), namely CMC (or Kollicoat-copolymer) is titrated with solutions of several cationic biocides (B), and particle formation is followed by measuring the increase in turbidity during the titration, as well as by optical inspection to detect flocculation.

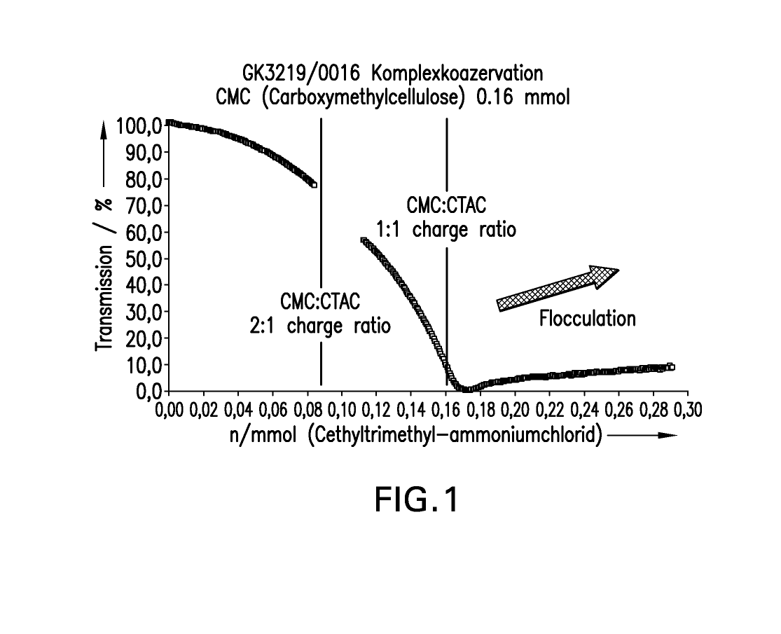

FIG. 1 shows the result of such a titration experiment with carboxymethylcellulose (CMC-solution) and CTAC-solution (aqueous solutions). The optical transmission is measured (in %). Upon titration of CMC with CTAC, the turbidity of the system increases. Once the point of 1:1 charge ratio is passed, flocculation occurs.

The charge ratio can be calculated based on the degree of substitution of CMC, which is from 0.65 to 0.9. The result of this experiment indicates that the coacervate particles formed from biocide (solution) and anionic polymer (solution) can best be prepared with a charge ratio from 2.5:1 to 1:1, preferably 2.5:1 to 1.1:1 in order to obtain stable compositions (dispersions).

In a further step, stable dispersions of CMC/CTAC coacervates are prepared at a charge ratio of 2:1.

Three different processes for the preparation of the biocide composition are evaluated:
a) slow titration (over 1 h),
b) rapid addition of CTAC by pipette, and
c) Mixing, preferably turbulent mixing.

The turbulent mixing, as continuous process, combines solutions of the coacervation components (B and P) rapidly and turbulently and thus avoids concentration gradients that could lead to inhomogeneous distribution of the partners in the particles.

In all three process variants, stable compositions (dispersions) can be obtained (stable against flocculation for over 14 days). After filtration to remove a minimal amount of large particles, the compositions are characterized by dynamic light scattering.

The mean diameters of the coacervate-particles are given in Table 1.

TABLE 1
Average, hydrodynamic particle size as determined by
a combination of dynamic and static light scattering

| Sample | Preparation Method | d (nm) |
|---|---|---|
| CMC/CTAC coacervates | Turbulent Mixing (c) | 347 |
| CMC/CTAC coacervates | Rapid Addition (b) | 448 |
| CMC/CTAC coacervates | Titration (a) | 359 |

The particle size distribution of the CMC/CTAC coacervates prepared by turbulent mixing shows that more than 90 percent of the particles obtained have a diameter from 200 to 900 nm, which is particularly useful for textile conservation.

For the preparation, an aqueous solution of carboxymethylcellulose sodium salt (Sigma Aldrich C 5678, 90 kDa, DS=0.65-0.9, 0.5% w CMC, flow rate: 25, 4 g/min. Maximum solubility in water is 4% w) is mixed with a solution of CTAC (2.7% w, 2.5 g/min) or with PHMB (1.56% w, 2.28 g/min), respectively. Mixing was conducted in a T-piece, into which the two aqueous solutions were fed using two HPLC pumps. The combined streams are collected in a beaker as a colorless, turbid dispersion (solids content (CMC/CTAC ca 0.6% w and CMC/PHMB 0.5% w), containing a few larger particles. After filtration (1.2 μm, material PET), the dispersions are evaluated by a combination of dynamic and static light scattering.

The dispersions obtained as described are applied to the textiles either by spraying the dispersions on the fabric or by dunking the fabric into the dispersions once. In both cases, the dispersions were not further diluted. Then, the fabrics are dried on air. For comparison (positive control), solutions of CTAC (2.7% w) and PHMB (1.6% w), respectively are applied in just the same ways. Fabrics are weighed before and after application on order to determine the amount of material deposited (see Table 1 for results).

Dispersions of a coacervate of the anionic polymer CMC with the biocide PHMB are obtained in an analogous fashion.

### Example 4

### Biocide Activity

For biocide evaluation, the compositions of CMC/CTAC and CMC/PHMB and Kollicoat MAE 100P/CTAC and Kollicoat MAE 100P/PHMB are prepared by turbulent mixing of the two solutions and deposition on two different samples of PP textiles. Application can be either by dunking the textile in the dispersion or by spraying the dispersion onto the textile.

Also, different amounts of coacervate are deposited (e.g. 1 to 6% w). The treated fabrics, along with untreated controls and fabrics, onto which the unformulated biocides are sprayed, are submitted to a standardized “quick-kill test” (AATCC-100).

In this test, the reduction in population of Staphylococcus aureus and Escherichia coli, respectively is measured upon introduction of the (treated) fabric into the cell culture. Some results are summarized in Table 2.

Untreated textile that is cut out from a commercial suit made from nonwoven PP and does not show any biocide activity after 2 hours (blank/negative control). The same textile, spray-treated with aqueous solutions of either CTAC or PHMB, respectively, (2-3% w), showed biocide activity after 5 minutes contact time, for S. aureus (log-reduction of the population by >4 units).

For E. coli, PHMB showed killing after 5 min. CTAC was however not very active after 5 minutes, (log-reduction by 1.5 units) but very effective only after 2 h.

These results function as positive control. Spraying an aqueous solution of any substance with subsequent drying will leave the substance on the substrate, irrespective of adhesion efficacy. Upon immersion in the aqueous cell culture medium, the substance is dissolved in the medium and its action is not anymore influenced by the substrate.

TABLE 2

| | | | E. coli | S. aureus |
|---|---|---|---|---|
| | | | Log | Log |
| Sample | Sample treatment | Time | reduction | reduction |
| Blank | | 5 min | | 1.6E+06 |
| Blank | | 2 h | | 1.2E+06 |
| A | CTAC/CMC | 2 h | >4.7 | >4.1 |
| | 2.3%. Sprayed | | >4.7 | >4.1 |
| B | PHMB/CMC | 5 min | 3.5 | 1.5 |
| | 2.4%. Dipped | | 3.4 | 1.4 |
| C | PHMB/CMC | 2 h | >4.7 | >4.1 |
| | 2.4%. Dipped | | >4.7 | >4.1 |
| D | PHMB/CMC | 2 h | >4.7 | >4.1 |
| | 6.5%. Sprayed | | >4.7 | >4.1 |
| E | PHMB | 5 min | >4.5 | >4.2 |
| | 3.0%. Sprayed | | >4.5 | >4.2 |
| F | CTAC/Kollicoat | 2 h | 3.8 | 3.6 |
| | 1.06%. Sprayed | | | |

Results of a standardized “quick-kill test” AAT (CC-100) conduct All biocide textiles with the combination (B and P) were strongly active against both strains after 2 h (reduction to below detection threshold). After 5 minutes contact time, activity for the formulated textiles with biocide (B) plus polymer (P) appeared high and even after soaking in water, activity was strong. Also a long term biocide effect was observed with the textiles treated with both components (B and P).

One explanation is that the active biocide (B) needs to be released from the coacervate in order to be effective and that this process occurs for hours. For application, such an effect is of advantage: If a coacervate formulation allows for effective adhesion of the biocide substance and this active is slowly released from the depot, this formulation can well equip the synthetic textile with biocide properties over its complete lifetime in surgical tissue/clothing applications.

The formulation of well-known, positively charged biocide substances (B) as complex coacervate particles with anionic polymers (P) such as CMC is technically easy feasible also in a high volume. PP textiles treated with these formulations show long lasting (several months) and fast acting biocide properties.

Adhesion can be maximized with stable dispersions of coacervate particles that can be prepared with no surface charge. The coacervate can preferably be “soft” according to its macroscopic rheological properties.

In order to achieve this, polymers can be selected that are capable of participating in coacervate formation and provide for steric stabilization of the dispersed particles of 200-900 nm. The polymers used carry weak anionic charge. In addition, the groups responsible for steric stabilization can provide for increased adhesion efficacy. The anionic copolymer products based on methacrylic acid/ethyl acrylate (such as Kollicoat) are particularly useful for an easy technical treatment of textiles combined with long-term biocide conservation of the synthetic textile.

### Example 5

### Preparation of Dispersions Containing Carboxymethyl Cellulose, Poly(Acrylamide-Co-Acrylic Acid) and Cetyltrimethylammonium Chloride

To 400 grams of a 2.0 wt % solution of carboxymethyl cellulose (MW 90,000, DS=0.7), 1.2 g of poly(acrylamide-co-acrylic acid) (20 wt % acrylamide, MW 200,000) and 7 ml of 2N NaOH is added and mixed until dissolved. 200 grams of a 4 wt % solution cetyltrimethylammonium chloride is then added to the well stirred solution over a 60 minute period. The reaction mixture is stirred for an addition 30 minutes and any coagulum formed is removed by passing the mixture through a 100 mesh screen.

### Example 6

### Preparation of Dispersions Containing Carboxymethyl Cellulose, Poly(Acrylic Acid) and Cetyltrimethylammonium Chloride

To 200 grams of a 3.0% solution of carboxymethyl cellulose (MW 90,000, DS=0.7) is added 10.5 ml of 1N NaOH and 1.5 grams of a 50% aqueous solution of poly(acrylic acid) (MW 5,000). With efficient stirring 150 grams of a 4% aqueous solution of cetyltrimethylammonium chloride is added over a 60 minute period. The reaction mixture is stirred for an addition 30 minutes and any coagulum formed is removed by passing the mixture through a 100 mesh screen.

### Example 7

### Treatment of Nonwoven Textiles

Nonwovens e.g. polypropylene can be treated by a dip and squeeze method. The dispersion is diluted to the desired concentration and then used to saturate the fabric sample. The excess is removed by passing the fabric through a textile padder and the samples are then dried.

### Example 8

### Biocide Activity

80 grams of the dispersion in Example 5 is diluted with 120 grams of water. A polypropylene spunbond nonwoven fabric is treated with the diluted suspension according to Example 7. A wet pick up of 200% was achieved which corresponds to a 2.2% loading of the antimicrobial dispersion. The sample was evaluated using the quick kill adaption of the AATCC 100 and challenged with Klebsiella pneumoniae ATCC 51504 with a 5 minute contact time.

The results are listed in the table 3 below

| | | Klebsiella pneumoniae |
|---|---|---|
| Sample | Treatment | Log reduction |
| Blank | None | <1 |
| Example 5 | CTAC/CMC/AA | 4.2 |

Treated nonwoven according to the invention is challenged with Pseudomanas aeruginosa ATCC BAA 427.

The results are in the table 4 below

| | | | Log reduction |
|---|---|---|---|
| | | | Pseudomonas |
| Sample | Time | Treatment | aeruginosa |
| GV1 | 5 minutes | 0.5% Active 1% | 3.0 |
| | 30 minutes | total solids | 5.0 |
| | | (inventive dispersion) | |
| GV2 | 5 minutes | 0.6% Active 1.25% | 5.0 |
| | 30 minutes | total solids | 2.3 |
| | | (inventive dispersion) | |

There are further technical advantages in having the additional anionic polymer in combination with the carboxymethyl cellulose (CMC).

The excess of negative charges can stabilize the dispersion containing the biocide. Polyacrylic acids have a high charge density—about 4 times that of CMC—so further charge can be added with less material. Polyacrylic acids or the poly(acrylamide-co-acrylic) acids can be used in addition to or instead of CMC (as the sole anionic polymer).

For a 2:1 charge ratio, a dispersion can be made from a 2% by weight CMC solution which will result in a dispersion containing 1% of the quaternary ammonium compound. By adding the poly(acrylamide-co-acrylic acid) to boost the anionic charge one can make dispersions with 2% loading of the quaternary ammonium compound making it more potent for treatment.

Acrylic acid/methacrylacid copolymers and acrylic acid homopolymers can be chosen as component having high charge density.

### Example 9

The addition of a highly charged anionic polymer was found to allow a higher weight percentage of the antimicrobial (biocide component) in the dispersion, the dispersions with the added anionic polymer will be more active against microbes.

### Virucidal Activity

Bovine Viral Diarrhea Virus (Surrogate for Human Hepatitis C Virus) in Table 5

| Sample | Treatment | Contact Time: | Log Reduction |
|---|---|---|---|
| GV001 | Nonwoven | 30 minutes | >3.52 ± 0.30 |
| | polypropylene | 5 minutes | >1.40 ± 0.21 |
| | treated with | | |
| | dispersion | | |
| | according to | | |
| | the invention | | |

Influenza A Virus (H1N1) (2009 pandemic strain) in Table 6

| Sample | Treatment | Contact Time: | Log Reduction |
|---|---|---|---|
| GV001 | Nonwoven | 30 minutes | 4.35 ± 0.00 |
| | polypropylene | 5 minutes | 1.68 ± 0.34 |
| | treated with | | |
| | dispersion | | |
| | according to | | |
| | the invention | | |

Rhinovirus Misting Study in Table 7

| Sample | Treatment | Contact Time: | Log Reduction |
|---|---|---|---|
| GV001 | Nonwoven | 30 minutes | 4.35 ± 0.00 |
| | polypropylene | 5 minutes | 2.18 ± 0.08 |
| | treated with | | |
| | dispersion | | |
| | according to | | |
| | the invention | | |

### Example 10

To 400 mo of a 2.0 wt. % solution of carboxymethyl cellulose (MW 90,000, DS=0.7), 1.2 g of maleic acid/olefin copolymer (Mw of 12,000, pH 11, 15 wt. % of the carboxymthyl cellulose) is added and mixed until dissolved. 100 MI of a 4 wt. % solution of cetyltrimethylammonium chloride is then added to the well stirred solution over a 60 minute period. The reaction mixture is stirred for an additional 30 minutes and any coagulum removed by passing the mixture through a 100 mesh screen.

The dispersion is stable against flocculation over 14 days.

### Example 11

Example 10 is applied on a spunbound polypropylene nonwoven fabric (1.3 wt. % loading, 0.6% active and the antimicrobial activity is evaluated according to “quick-kill test” (AATCC-100) above. The “active” refers to cetyltrimethylammonium chloride.

TABLE 8
Antimicrobial data for dispersion on nonwoven

| | Log Reduction Contact time: |
|---|---|
| Pathogen | 5 minutes |
| Staphylococcus aureus, MRSA/G+ | Log 5 |
| Klebsiellla pneumonia/G− | Log 3 |

1. Process for the treatment of a synthetic textile (T) comprising a biocide dispersion comprising a coacervate or complex of at least one cationic biocide (B) and at least one anionic polymer (P) which comprises the step of treating the synthetic textile with an aqueous composition containing the cationic biocide(s) (B) in a concentration (c1) and containing the anionic polymer(s) (P) in a concentration (c2), wherein the concentrations (c1) and (c2) are selected so that the ratio (R) of negative charges of the anionic polymer (P) to the positive charges of the cationic biocide (B) is between 10:1 and 1:1.

2. Process for the treatment of a synthetic textile (T) according to claim 1, wherein the synthetic textile (T) comprises a synthetic polymer from the group of polyolefins, polyesters and polyamides.

3. Process for the treatment of a synthetic textile (T) according to claim 1, wherein the anionic polymer(s) (P) is an anionic polyelectrolyte selected from the group of carboxymethyl cellulose, alginic acid, homopolymers of poly(acrylic acid), poly(methylacrylic acid) and copolymers of (meth)acrylic acid and (meth)acrylamide, N-methyl(meth)acrylamide, N,N-dimethyl(meth)acrylamide and copolymers of maleic acid, itaconic acid, crotonic acid, maleic acid, fumaric acid and diisobutylene, butylene, ethylene, propylene.

4. Process for the treatment of a synthetic textile (T) according to claim 1, wherein the cationic biocide (B) is selected from the group of
quaternary ammonium compounds of the formula (I): 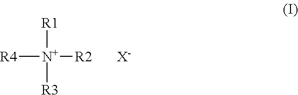
wherein R₁, R₂, R₃ and R₄ are independent of each other C₁₋₂₀ alkyl, C₁₋₂₀ alkyl alkyl substituted by one or more hydroxy or benzyloxy group and/or interrupted by one or more oxygen, C₇₋₁₅ aralkyl, or C₇₋₁₅ aralkyl substituted by one or more C₁₋₂₀ alkyl, hydroxy, C₁₋₂₀ alkyloxy and/or benzyloxy groups, and
X⁻ is a halide (for example, chloride, bromide or iodide), hydroxide, phosphate, phosphonate, carbonate, sulfate, carboxylate anion, nitrate, methosulfate or acetate;
polyhexymethylenbiguanid compounds;
combination of both types of cationic biocides.

5. Process for the treatment of a synthetic textile (T) according to claim 1, wherein the aqueous composition comprises 0.05 to 5% by weight (based on the total weight the aqueous composition) of the cationic biocide (B) and comprising 0.05 to 10% by weight (based on the total weight the aqueous composition) of the anionic polymer(s) (P).

6. Process for the treatment of a synthetic textile (T) according to claim 1, wherein the aqueous composition, comprising 0.05 to 5% by weight (based on the total weight the aqueous composition) of a cationic biocide (B) and 0.05 to 10% by weight (based on the total weight the aqueous composition) of anionic polymer(s) (P) is sprayed, dipped, padded, immersed or coated onto the synthetic textile (T).

7. Process for the treatment of a synthetic textile (T) according to claim 1, wherein the aqueous composition, comprising 0.1 to 5% by weight of CTAC and/or PHMB and 0.1 to 10% by weight (based on the total weight the aqueous composition) of at least one anionic polymer (P) selected from the group of carboxy methylcellulose, alginic acid, hyaluronic acid, copolymers of acrylic acid with acrylic acid ester, copolymers of methacrylic acid with acrylic acid ester, copolymers of (meth)acrylic acid with acrylamide, copolymers of maleic acid, itaconic acid, crotonic acid, maleic acid, fumaric acid and diisobutylene, butylene, ethylene, propylene.

8. An aqueous biocide dispersion for the treatment of a synthetic textile (T) comprising a coacervate or complex of a cationic biocide (B) and at least one anionic polymer (P), containing the cationic biocide (B) in a concentration (c1) and containing the anionic polymer(s) (P) in a concentration (c2), wherein the concentrations (c1) and (c2) are selected so that the ratio (R) of negative charges of the anionic polymer (P) to the positive charges of the cationic biocide (B) is between 10:1 and 1:1, and wherein the cationic biocide (B) and an anionic polymer (P) are homogenously distributed within the composition.

9. The aqueous biocide dispersion for the treatment of a synthetic textile (T) according to claim 8 which achieves a reduction in microbial activity on the synthetic textile (T) of at least a log reduction of 3 against gram positive and gram negative bacteria within 5 minutes of contamination.

10. The biocide dispersion for the treatment of a synthetic textile (T) according to claim 8, containing at least 50% by weight of water and containing as cationic biocide (B) 0.05 to 5% by weight of at least one compound from the group of cetyltrimethyl ammonium salts and polyhexamethylenbiguanid compounds.

11. Biocide composition for the treatment of a synthetic textile (T) according to claim 8, containing 0.05 to 5% by weight of at least one anionic polymer (P) selected from the group of carboxymethyl cellulose, alginic acid, poly(acrylic acid), copolymers of acrylic acid, poly(methacrylic acid) and copolymers of methacrylic acid.

12. Process for the preparation of a biocide dispersion according to claim 8, comprising the steps of:
a) preparing an aqueous solution of at least one anionic polymer (P),
b) preparing an aqueous solution of at least one cationic biocide (B),
c) mixing the two aqueous solutions,
d) potentially removing the solvent from the biocide composition.

13. A synthetic textile (T) comprising at least one cationic biocide (B) and at least one anionic polymer (P) prepared by using the process as described in claim 1.

14. The synthetic textile (T) according to claim 13, further comprising a nonionic surfactant.

15. An article comprising a synthetic textile (T) of claim 13, selected from the group consisting of a surgical drape, a cover, a drape, a sheet, a linen, a padding, a gauze dressing or a garment, such as gown, robe, face mask, head cover, shoe cover and glove.

16. The process according to claim 1, wherein the textile is characterized by a reduction in microbial activity against Listeria spp, Salmonella spp, Campylobacter spp, Actinomyces spp, C. difficle, C. perferengies, VRE (vancomycin resistant enterococci), Candida albicans, E. coli, E. faecalis, Staphylococcus saprophyticus, Citrobacter diversus, Proteus mirabilis, Enterobacter aregenes, Enterobacter clocae, Salmonella enterica, Staphylococcus aureus, Klebsiella pneumonia, Aspergillus niger, Aureobasidium pullulans, Penicillium funiculosum, Methicillin-resistant Staphylococcus aureus (MRSA) Streptococcus Pneumonia and Pseudomonas aeruginosa including all viruses and fungi.

17. The process according to claim 1, where the textile is characterized by a reduction in viral activity.
